(19) United States
(12) Patent Application Publication
(10) Pub. No.: US 2022/0292690 A1
(43) Pub. Date: Sep. 15, 2022

(54) DATA GENERATION METHOD, DATA GENERATION APPARATUS, MODEL GENERATION METHOD, MODEL GENERATION APPARATUS, AND PROGRAM

(71) Applicant: Preferred Networks, Inc., Tokyo (JP)

(72) Inventors: Minjun LI, Tokyo (JP); Huachun ZHU, Tokyo (JP); Yanghua JIN, Tokyo (JP); Taizan YONETSUJI, Tokyo (JP)

(21) Appl. No.: 17/804,359

(22) Filed: May 27, 2022

Related U.S. Application Data
(63) Continuation of application No. PCT/JP2020/043622, filed on Nov. 24, 2020.

(30) Foreign Application Priority Data
Nov. 28, 2019 (JP) 2019-215846

(51) Int. Cl. G06T 7/174; G06T 11/60; G06F 3/04845; G06N 3/04

(52) U.S. Cl. CPC G06T 7/174; G06T 11/60; G06F 3/04845; G06N 3/0454

(57) ABSTRACT

A data generation method includes generating, by at least one processor, an output image by using a first image, a first segmentation map, and a first neural network, the first segmentation map being layered.

### CROSS-REFERENCE TO RELATED APPLICATIONS

This application is a continuation application of International Application No. PCT/JP2020/043622 filed on Nov. 24, 2020, and designating the U.S., which is based upon and claims priority to Japanese Patent Application No. 2019-215846, filed on Nov. 28, 2019, the entire contents of which are incorporated herein by reference.

### BACKGROUND

### 1. Technical Field

The present disclosure relates to a data generation method, a data generation apparatus, a model generation method, a model generation apparatus, and a program.

### 2. Description of the Related Art

With the progress of deep learning, various neural network architectures and training methods have been proposed and used for various purposes.

For example, in the field of image processing, various research results on image recognition, object detection, image synthesis, and the like have been achieved by using deep learning.

For example, in the field of image synthesis, various image synthesis tools such as GauGAN and Pix2PixHD have been developed. With these tools, for example, landscape images can be segmented by the sky, mountains, sea, or the like, and image synthesis can be performed using a segmentation map in which each segment is labeled with the sky, mountains, sea, or the like.

An object of the present disclosure is to provide a user-friendly data generation technique.

### SUMMARY

According to one aspect of the present disclosure, a data generation method includes generating, by at least one processor, an output image by using a first image, a first segmentation map, and a first neural network, the first segmentation map being layered.

According to one aspect of the present disclosure, a data displaying method implemented by at least one processor, the method comprising displaying a first segmentation map on a display device, displaying information on a plurality of layers to be edited on the display device, obtaining an editing instruction relating to a first layer included in the plurality of layers from a user, displaying a second segmentation map, generated by editing the first layer of the first segmentation map based on the editing instruction from the user, on the display device, and displaying an output image, generated based on a first image and the second segmentation map, on the display device.

### BRIEF DESCRIPTION OF THE DRAWINGS

FIG. 1 is a schematic diagram illustrating a data generation method according to an embodiment of the present disclosure;

FIG. 2 is a block diagram illustrating a functional configuration of of a data generation apparatus according to an embodiment of the present disclosure;

FIG. 3 is a diagram illustrating a layered segmentation map as an example according to an embodiment of the present disclosure;

FIG. 4 is a diagram illustrating an example of a data generation process according to an embodiment of the present disclosure;

FIG. 5 is a diagram illustrating a feature map conversion process using a segmentation map according to an embodiment of the present disclosure;

FIG. 6 is a diagram illustrating a modification of the data generation process according to an embodiment of the present disclosure;

FIG. 7 is a diagram illustrating a modification of the data generation process according to an embodiment of the present disclosure;

FIG. 8 is a diagram illustrating a modification of the data generation process according to an embodiment of the present disclosure;

FIG. 9 is a flowchart illustrating a data generation process according to an embodiment of the present disclosure;

FIG. 10 is a diagram illustrating an example of a user interface according to an embodiment of the present disclosure;

FIG. 11 is a diagram illustrating an example of the user interface according to an embodiment of the present disclosure;

FIG. 12 is a diagram illustrating an example of the user interface according to an embodiment of the present disclosure;

FIG. 13 is a diagram illustrating an example of the user interface according to an embodiment of the present disclosure;

FIG. 14 is a diagram illustrating an example of the user interface according to an embodiment of the present disclosure;

FIG. 15 is a diagram illustrating an example of the user interface according to an embodiment of the present disclosure;

FIG. 16 is a diagram illustrating an example of the user interface according to an embodiment of the present disclosure;

FIG. 17 is a diagram illustrating an example of the user interface according to an embodiment of the present disclosure;

FIG. 18 is a diagram illustrating an example of the user interface according to an embodiment of the present disclosure;

FIG. 19 is a diagram illustrating an example of the user interface according to an embodiment of the present disclosure;

FIG. 20 is a block diagram illustrating a functional configuration of a training apparatus as an example according to an embodiment of the present disclosure;

FIG. 21 is a diagram illustrating a feature map conversion process using a segmentation map according to an embodiment of the present disclosure;

FIG. 22 is a diagram illustrating a neural network architecture of a segmentation model according to an embodiment of the present disclosure;

FIG. 23 is a flowchart illustrating a training process according to an embodiment of the present disclosure; and

FIG. 24 is a block diagram illustrating a hardware configuration of of a data generation apparatus and a training apparatus according to an embodiment of the present disclosure.

### DETAILED DESCRIPTION

In the following, embodiments of the present disclosure will be described with reference to the drawings. In the following examples, a data generation apparatus using a segmentation map and a training apparatus for training an encoder and a decoder of the data generation apparatus are disclosed.

### Outline of Present Disclosure

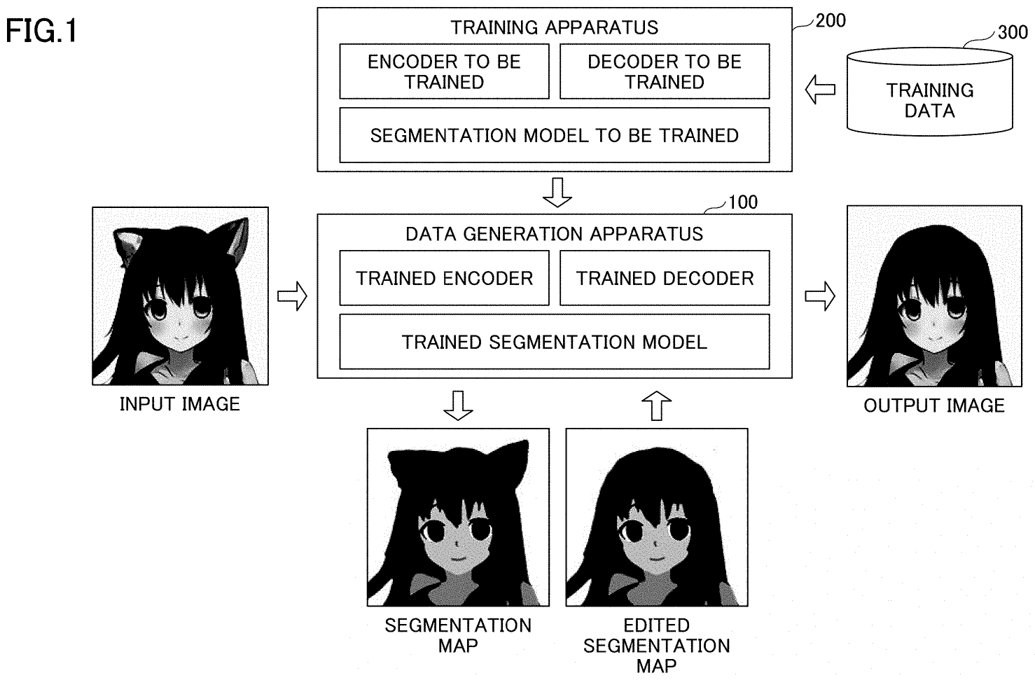

As illustrated in FIG. 1, a data generation apparatus 100 according to an embodiment of the present disclosure includes an encoder, a segmentation model, and a decoder implemented as any type of machine learning model such as a neural network. The data generation apparatus 100 presents to a user a feature map generated from an input image by using the encoder and a layered segmentation map (first segmentation map) generated from the input image by using the segmentation model. Then the data generation apparatus 100 acquires an output image from the decoder based on the layered segmentation map (a second segmentation map different from the first segmentation map) (in the illustrated example, both ears have been deleted from the image of the segmentation map) edited by the user. The output image is generated by reflecting the edited content of the edited layered segmentation map onto the input image.

A training apparatus 200 uses training data stored in a database 300 to train the encoder and the decoder to be provided to the data generation apparatus 100 and provides the trained encoder and decoder to the data generation apparatus 100. For example, the training data may include a pair of image and the layered segmentation map as described below.

### Data Generation Apparatus

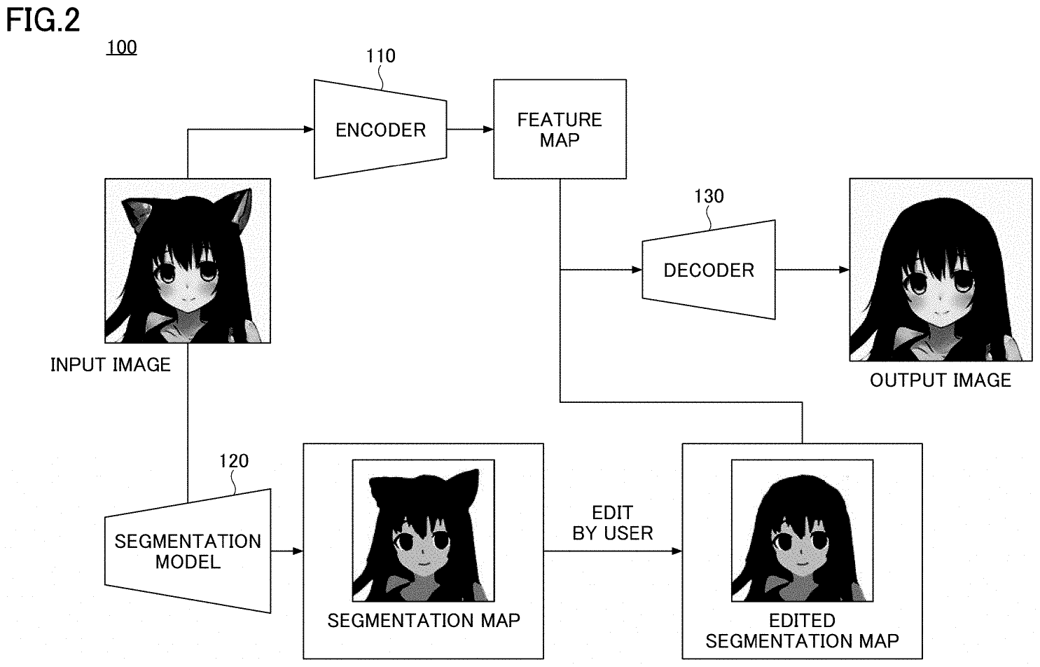

The data generation apparatus 100 according to the embodiment of the present disclosure will be described with reference to FIG. 2 to FIG. 5. FIG. 2 is a block diagram illustrating a functional configuration of the data generation apparatus 100 according to the embodiment of the present disclosure.

As illustrated in FIG. 2, the data generation apparatus 100 includes an encoder 110, a segmentation model 120, and a decoder 130.

The encoder 110 generates a feature map of data such as an input image. The encoder 110 is comprised of a trained neural network trained by the training apparatus 200. The neural network may be implemented, for example, as a convolutional neural network.

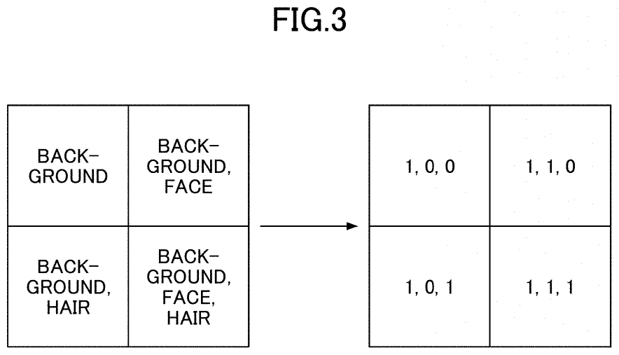

The segmentation model generates a layered segmentation map of data such as input images. In the layered segmentation map, for example, one or more labels may be applied to each pixel of the image. For example, with respect to the input image of a character as illustrated in FIG. 2, a part of the face being covered by the front hair is hidden in the front hair area, and the background is further behind the face. The layered segmentation map is composed of a layer structure in which a layer representing front hair, a layer representing a face, and a layer representing a background are superimposed. In this case, the layer structure of the layered segmentation map may be represented by a data structure such as illustrated in FIG. 3. For example, the pixels in the area where the background is displayed are represented by “1, 0, 0”. Further, the pixels in the area where the face is superimposed on the background are represented by “1, 1, 0”. Further, the pixels in the area where the hair is superimposed on the background are represented by “1, 0, 1”. Further, the pixels in the area where the face is superimposed on the background and the hair is further superimposed on the face are represented by “1, 1, 1”. For example, each layer is held by a layer structure from the object superimposed on the highest order (the hair in the illustrated character) to the object superimposed on the lowest order (the background in the illustrated character). According to such a layered segmentation map, when the user edits the layered segmentation map to delete the front hair, the face of the next layer will be displayed in the deleted front hair area.

The segmentation model 120 may be comprised of a trained neural network trained by the training apparatus 200. The neural network may be implemented, for example, as a convolutional neural network such as a U-Net type, which will be described below. Further, generating segmentation and layering may be performed in a single model, or may be performed using different models.

The decoder 130 generates an output image from the layered segmentation map and the feature map. Here, the output image can be generated to reflect the edited content of the layered segmentation map onto the input image. For example, when the user edits the layered segmentation map to delete the eyebrows of the image of the layered segmentation map of the input image and to replace the deleted portion with the face of the next layer (face skin), the decoder 130 generates an output image in which the eyebrows of the input image are replaced by the face.

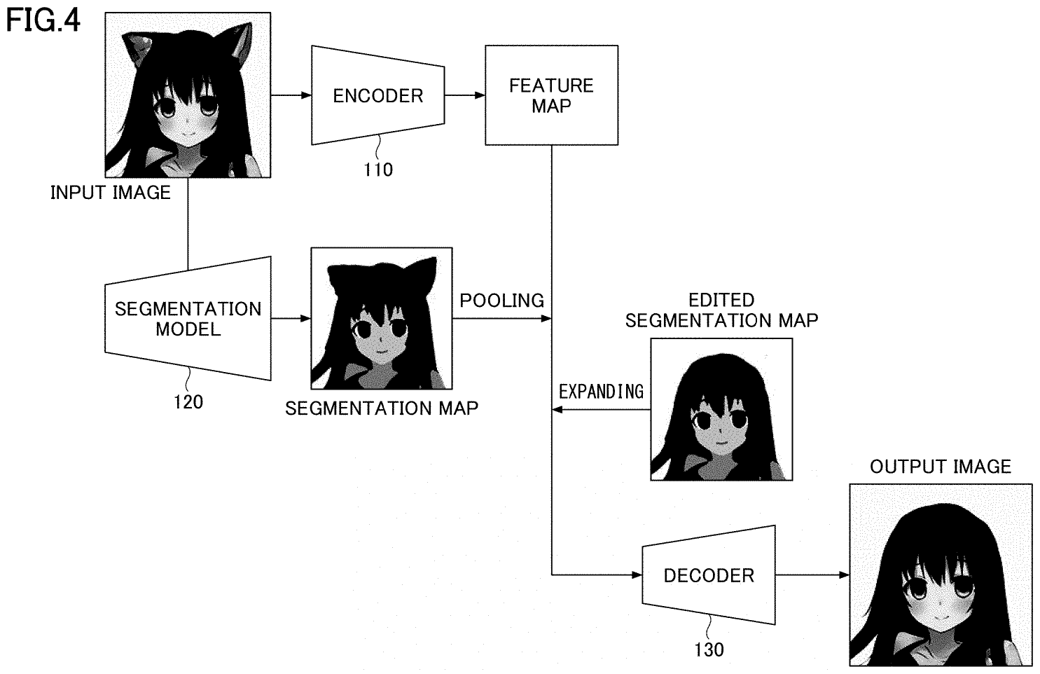

In one embodiment, as illustrated in FIG. 4, the feature map generated by the encoder 110 is pooled (for example, average pooling) with the layered segmentation map generated by the segmentation model 120 to derive a feature vector. The derived feature vector is expanded by the edited layered segmentation map to derive the edited feature map. The edited feature map is input to the decoder 130 to generate an output image in which the edited content for the edited area is reflected in the corresponding area of the input image.

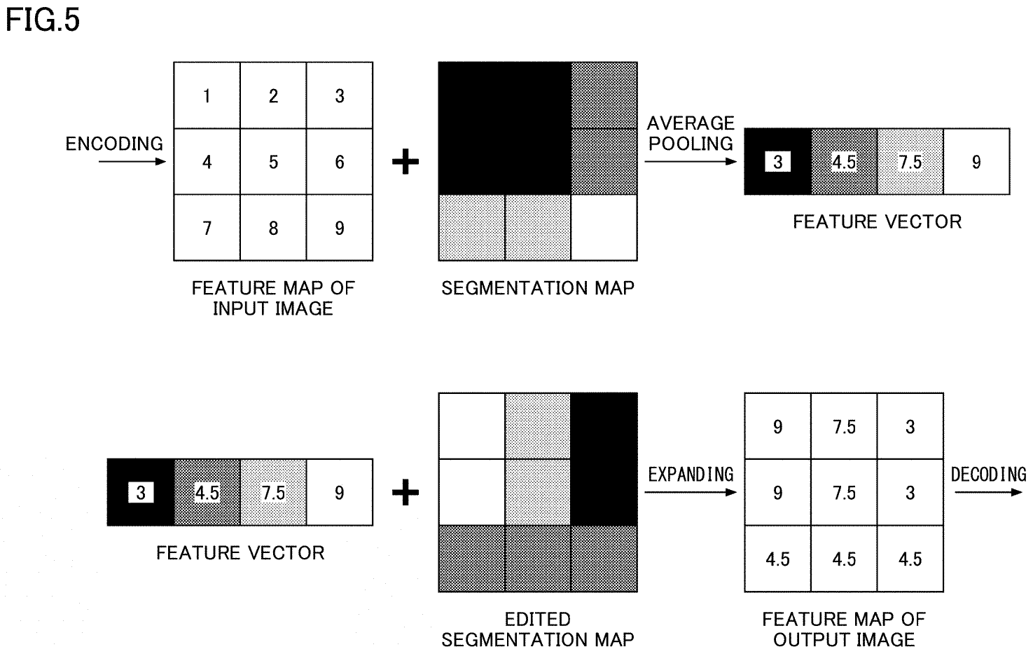

Specifically, as illustrated in FIG. 5, when the encoder 110 generates the feature map of the input image as illustrated and the segmentation model 120 generates the layered segmentation map as illustrated, average pooling with respect to the generated feature map and the highest layer of the layered segmentation map is performed to derive the feature vector as illustrated. The derived feature vector is expanded by the edited layered segmentation map as illustrated. Then the feature map as illustrated is derived to be input into the decoder 130.

The decoder 130 is comprised of a trained neural network by training apparatus 200. The neural network may be implemented, for example, as a convolutional neural network.

### Modification

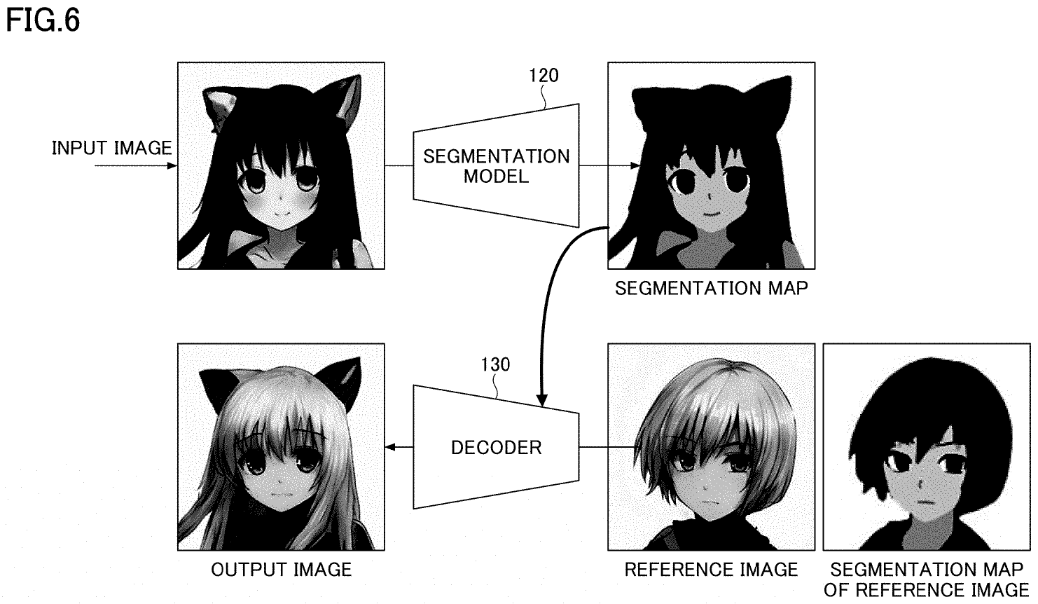

Next, various modifications of the data generation process of the data generation apparatus 100 according to an embodiment of the present disclosure will be described with reference to FIG. 6 to FIG. 8.

FIG. 6 is a diagram illustrating a modification of a data generation process of a data generation apparatus 100 according to an embodiment of the present disclosure. As illustrated in FIG. 6, a segmentation model 120 generates a layered segmentation map of an input image. A decoder 130 generates an output image, as illustrated, in which the content of the highest layer of the layered segmentation map is reflected in a reference image based on a feature map of the reference image (third data) which is different from the input image and the layered segmentation map generated from the input image.

The reference image is an image held by the data generation apparatus 100 for use by the user in advance, and the user can synthesize the input image provided by the user with the reference image. In the illustrated embodiment, the layered segmentation map is not edited, but the layered segmentation map to be synthesized with the reference image may be edited. In this case, the output image may be generated by reflecting the edited content with respect to the edited area of the edited layered segmentation map on the corresponding area of the reference image.

According to this modification, the input image is input into the segmentation model 120 and the layered segmentation map is acquired. The output image is generated from the decoder 130 based on the feature map of the reference image generated by the encoder 110 and the edited layered segmentation map with respect to the layered segmentation map or the layered segmentation map.

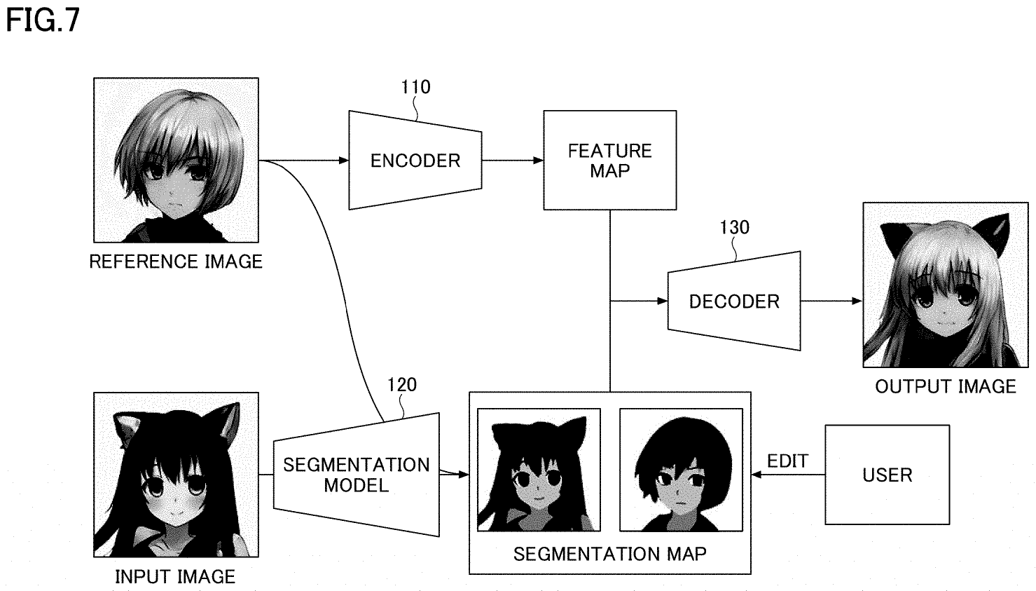

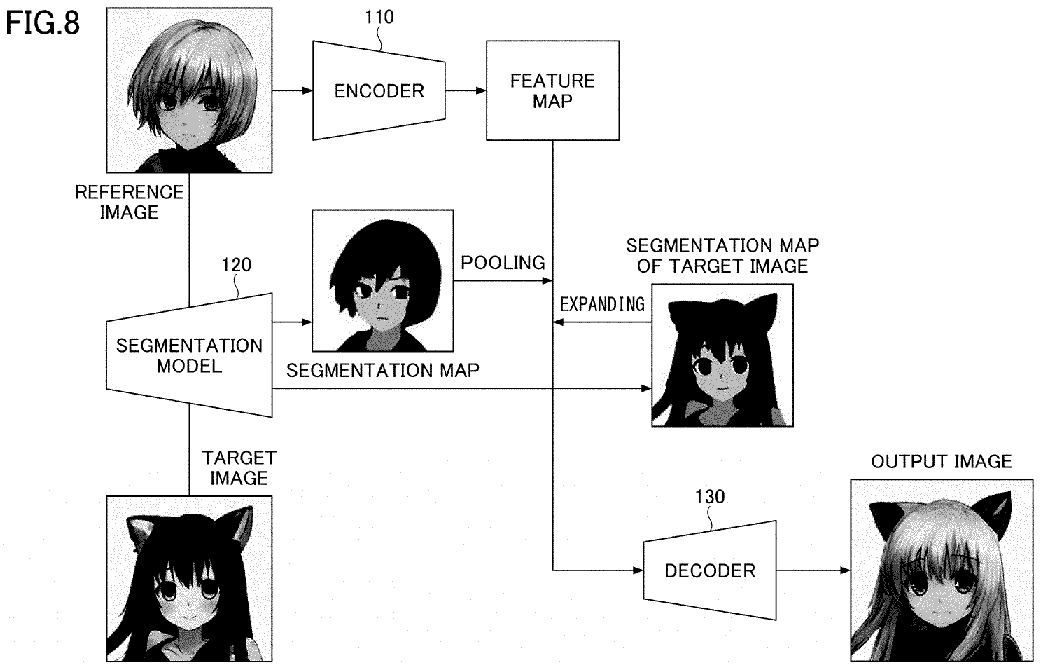

FIG. 7 is a diagram illustrating another modification of a data generation process of a data generation apparatus 100 according to an embodiment of the present disclosure. As illustrated in FIG. 7, a segmentation model 120 generates an input image, a reference image, and layered segmentation maps for each of the input image and the reference image. A decoder 130 generates an output image, as illustrated, in which the content of the edited layered segmentation map is reflected in a reference image based on a feature map of the reference image which is different from the input image and the layered segmentation map edited by the user for one or both of the two layered segmentation maps. With regard to the use of the two layered segmentation maps, for example, as illustrated in FIG. 8, the feature map of the reference image may be pooled by the layered segmentation map of the reference image and a derived feature vector may be expanded by the layered segmentation map of the input image.

According to this modification, the input image and the reference image are input into the segmentation model 120 to acquire their own layered segmentation map. The feature map of the reference image generated by the encoder 110 and/or the edited layered segmentation map with respect to the layered segmentation map is input into the decoder 130 to generate the output image.

Here, when the reference image is used, all of the features extracted from the reference image are not required to be used to generate an output image, but only a part of the features (for example, hair or the like) may be used. Any combination of the feature map of the reference image and the feature map of the input image (for example, weighted average, a combination of only the features of the right half hair and the left half hair, or the like) may also be used to generate an output image. Multiple reference images may also be used to generate an output image.

Although the above-described embodiments have been described with reference to a generation process for an image, the data to be processed according to the present disclosure is not limited thereto, and the data generation apparatus 100 according to the present disclosure may be applied to any other suitable data format.

### Data Generation Process

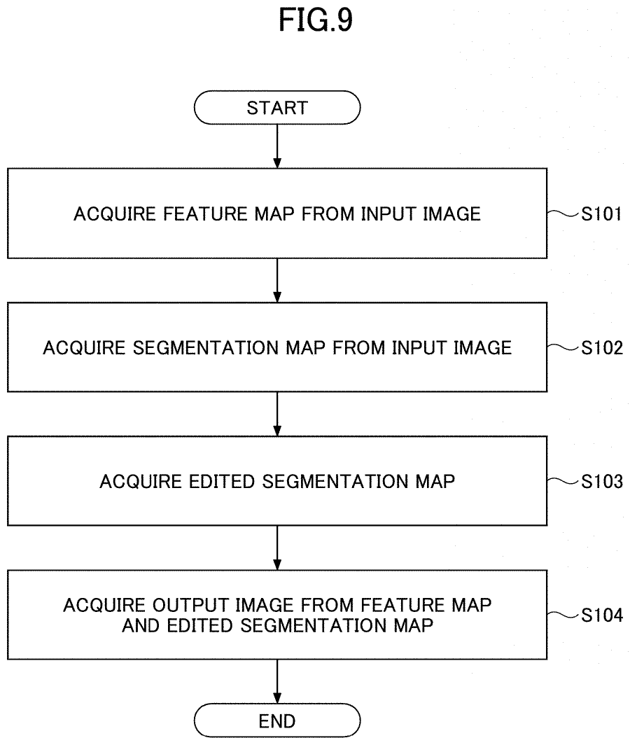

Next, a data generation process according to an embodiment of the present disclosure will be described with reference to FIG. 9. The data generation process is implemented by the data generation apparatus 100 described above, and may be implemented, for example, by one or more processors or a processing circuit of the data generation apparatus 100 that executes programs or instructions. FIG. 9 is a flowchart illustrating a data generation process according to an embodiment of the present disclosure.

As illustrated in FIG. 9, in step S101, the data generation apparatus 100 acquires a feature map from an input image. Specifically, the data generation apparatus 100 inputs the input image received from the user or the like into the encoder 110 to acquire an output image from the encoder 110.

In step S102, the data generation apparatus 100 acquires a layered segmentation map from the input image. Specifically, the data generation apparatus 100 inputs the input image into the segmentation model 120 to acquire the layered segmentation map from the segmentation model 120.

In step S103, the data generation apparatus 100 acquires an edited layered segmentation map. For example, when the layered segmentation map generated in step S102 is presented to the user terminal and the user edits the layered segmentation map on the user terminal, the data generation apparatus 100 receives the edited layered segmentation map from the user terminal.

In step S104, the data generation apparatus 100 acquires the output image from the feature map and the edited layered segmentation map. Specifically, the data generation apparatus 100 performs pooling, such as average pooling, with respect to the feature map acquired in step S101 and the layered segmentation map acquired in step S102 to derive a feature vector. The data generation apparatus 100 expands the feature vector by the edited layered segmentation map acquired in step S103, inputs the expanded feature map into the decoder 130, and acquires the output image from the decoder 130.

In the embodiment described above, the pooling was performed with respect to the feature map and the layered segmentation map, but the present disclosure is not limited thereto. For example, the encoder 110 may be any suitable model capable of extracting the feature of each object and/or part of an image. For example, the encoder 110 may be a Pix2PixHD encoder, and maximum pooling, minimum pooling, attention pooling, or the like rather than average pooling may be performed in the last feature map per instance. The Pix2PixHD encoder may be used to extract the feature vector by CNN or the like for each instance in the last feature map.

### User Interface

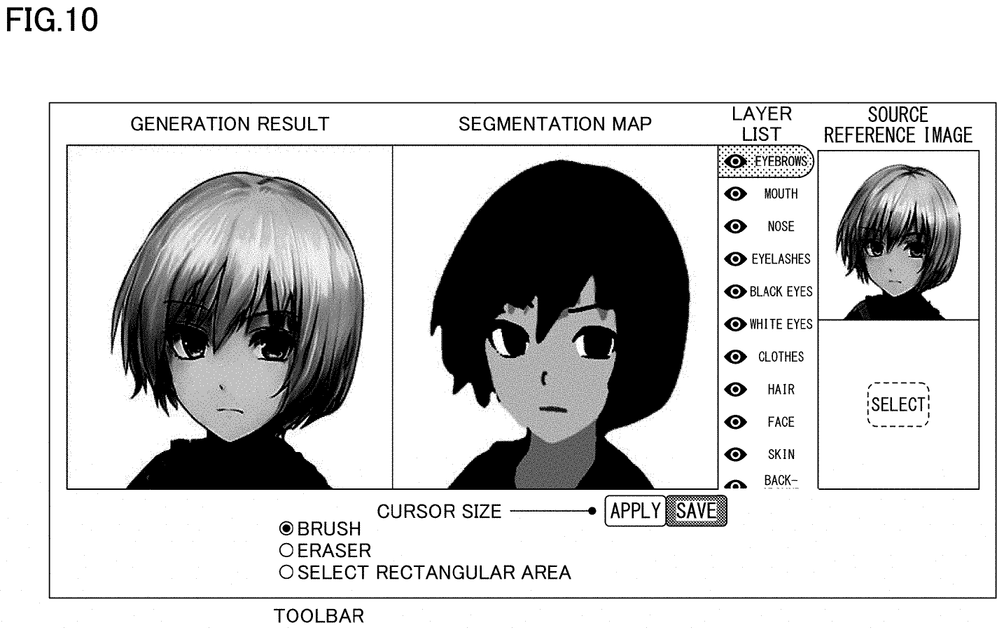

With reference to FIG. 10 to FIG. 19, a user interface provided by the data generation apparatus 100 according to an embodiment of the present disclosure will be described. The user interface may be implemented, for example, as an operation screen provided to the user terminal by the data generation apparatus 100.

A user interface screen illustrated in FIG. 10 is displayed when the reference image is selected by the user. That is, when the user selects the reference image, an editable part of the selected image is displayed as a layer list, and the output image generated based on the layered segmentation map before editing or the edited layered segmentation map generated from the reference image is displayed. That is, in the present embodiment, the segmentation is divided into layers for each part in which the segmentation is performed. In other words, the layers are divided for each group of recognized objects. As described above, the layered segmentation map may include at least two or more layers to toggle between displaying and hiding each layer on the display device. This enables to edit the segmentation map for each part more easily, as will be described later.

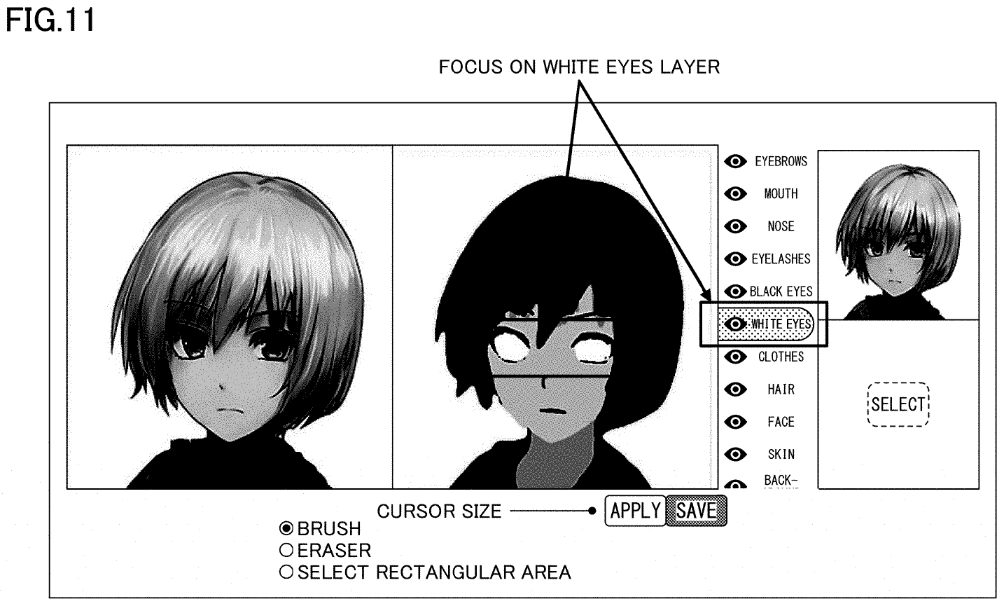

As illustrated in FIG. 11, when the user focuses on the eye portion of the layered segmentation map and selects the white eyes layer from the layer list, a layered segmentation map with the white eyes layer exposed is displayed.

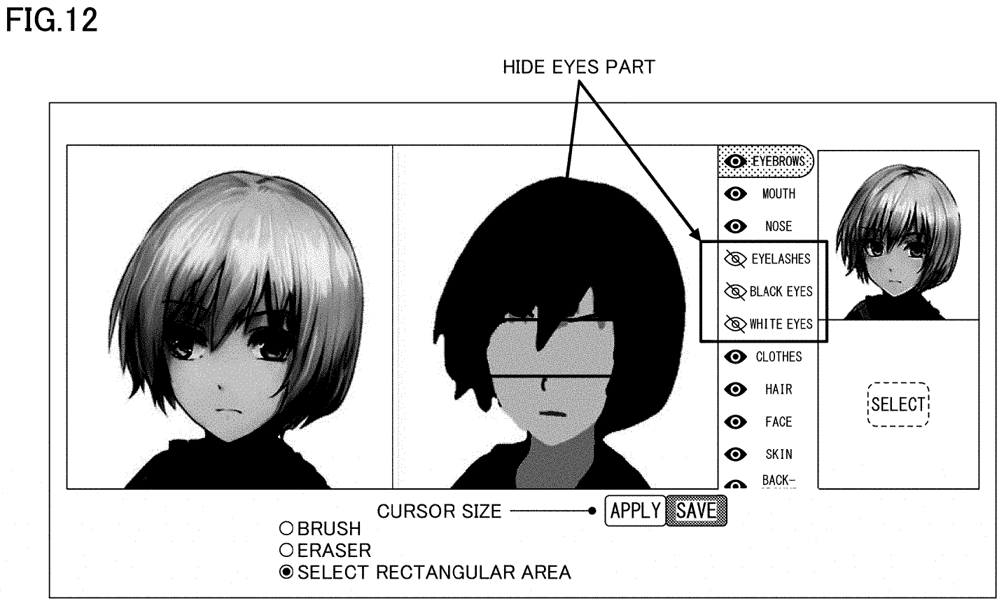

Further, as illustrated in FIG. 12, when the user focuses on the eye portion of the layered segmentation map, selects eyelashes, black eyes, and white eyes from the layer list, and further makes these parts invisible, these parts are hidden to display a layered segmentation map, with the face being exposed, of the next layer.

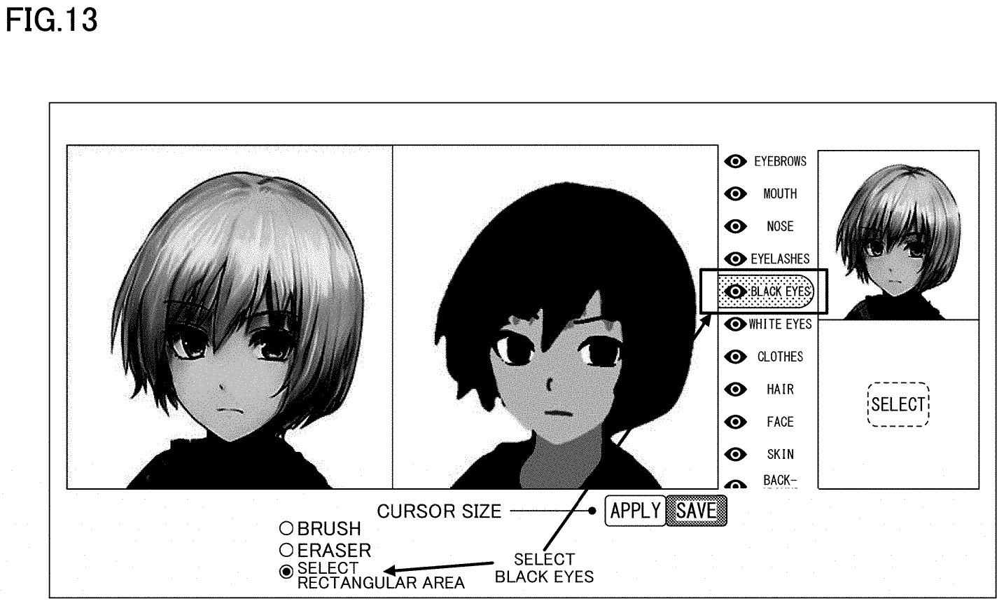

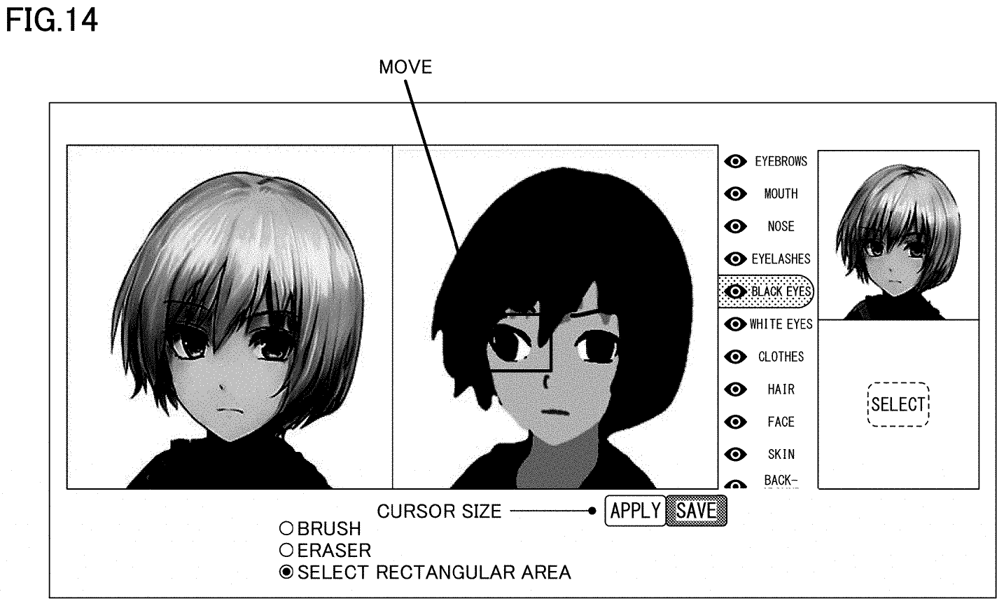

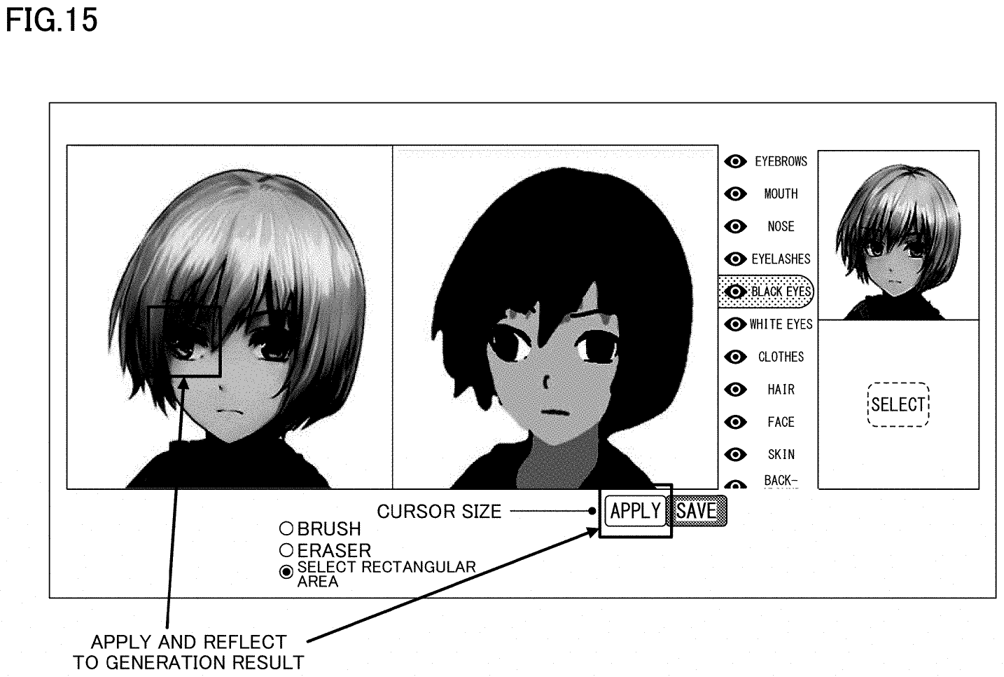

Further, as illustrated in FIG. 13, when the user selects the black eyes from the layer list and further selects “Select Rectangular Area”, a layered segmentation map with exposed rectangular area of the black eyes is displayed. Further, as illustrated in FIG. 14, the user can move the black eyes portion of the rectangular area of the layered segmentation map. Further, as illustrated in FIG. 15, when the user clicks on the “Apply” button, an output image is displayed in which the edited layered segmentation map is reflected.

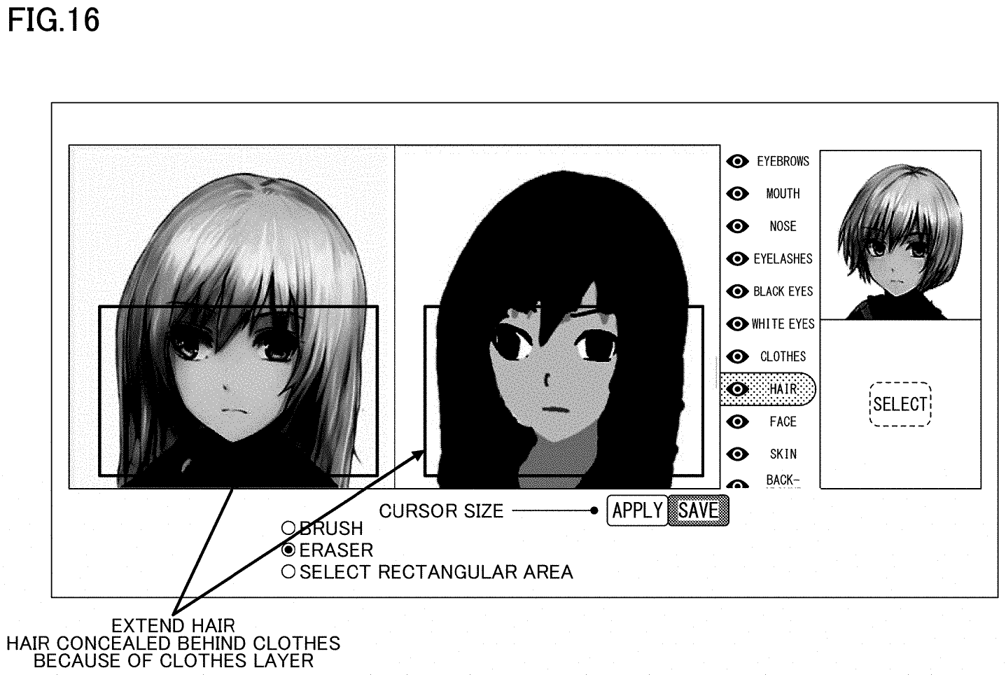

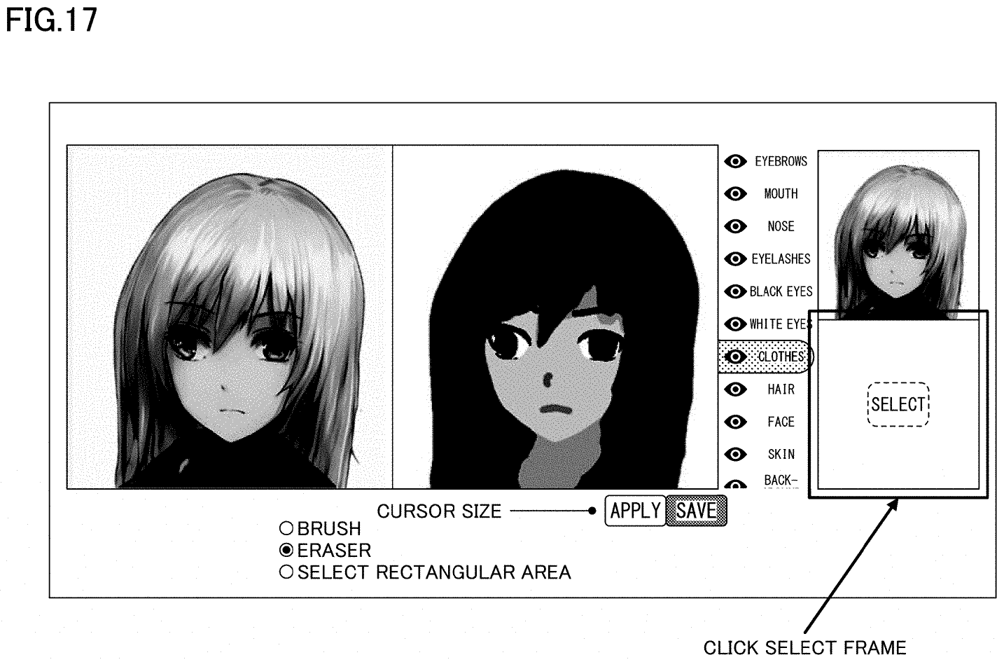

Further, as illustrated in FIG. 16, when the user edits the layered segmentation map to extend the hair of a character, the extended hair covers the clothing. In order to prevent the clothing being concealed due to the extended hair by the user, when the clothing layer in the layer list is selected as illustrated in FIG. 17, a layered segmentation map is edited such that the clothing is not concealed due to the extended hair.

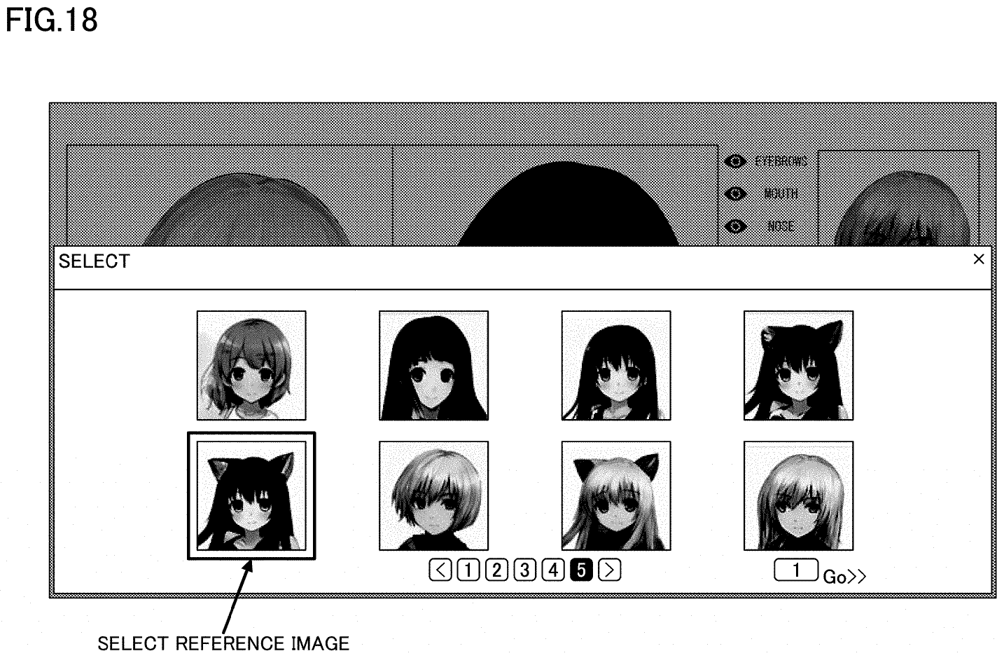

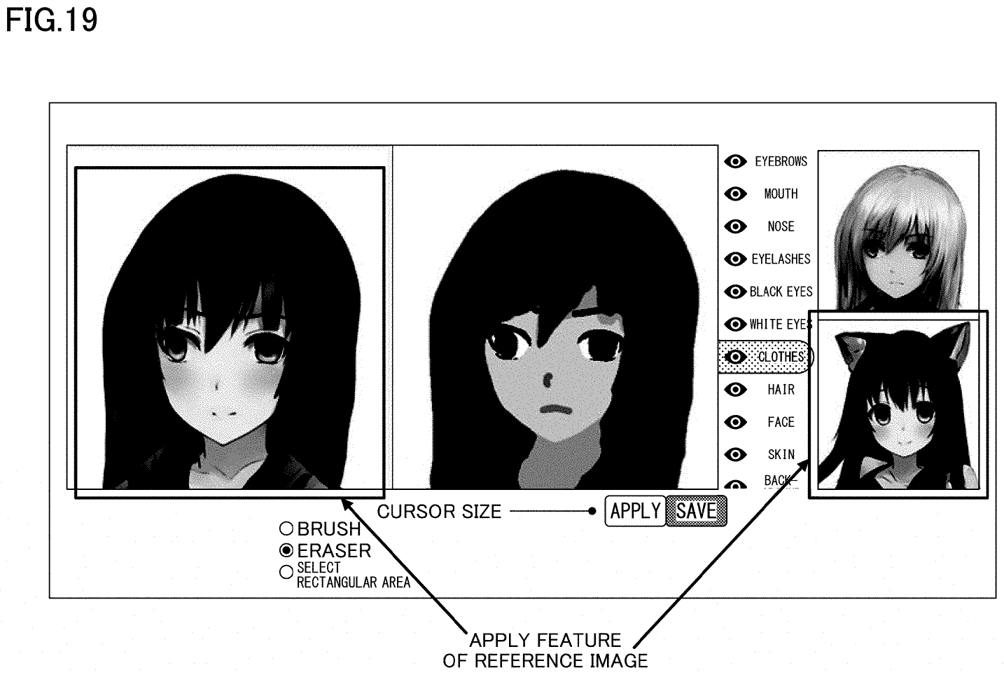

Here, as illustrated in FIG. 18, the user can select a desired image from multiple reference images held by the data generation apparatus 100. For example, as illustrated in FIG. 19, the feature of the selected reference image can be applied to the input image to generate an output image.

### Training Apparatus Apparatus (Model Generation Apparatus)

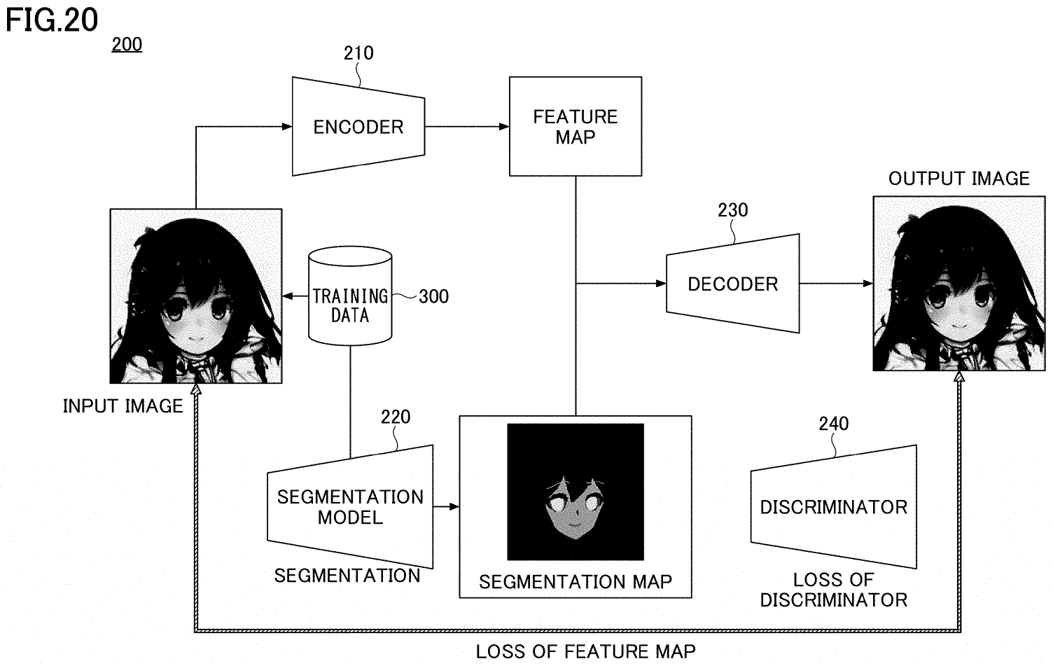

With reference to FIG. 20 to FIG. 22, a training apparatus 200 according to an embodiment of the disclosure will be described. The training apparatus 200 uses training data stored in a database 300 to train an encoder 210, a segmentation model 220, a decoder 230, and a discriminator 240 in an end-to-end manner. FIG. 20 is a block diagram illustrating the training apparatus 200 according to an embodiment of the present disclosure.

As illustrated in FIG. 20, the training apparatus 200 utilizes an image for training and a layered segmentation map to train the encoder 210, the segmentation model 220, and the decoder 230 in the end-to-end manner based on Generative Adversarial Networks (GANs). After the training is completed, the training apparatus 200 provides the encoder 210, the segmentation model 220, and the decoder 230 to the data generation apparatus 100, as the trained encoder 110, the trained segmentation model 120, and the trained decoder 130.

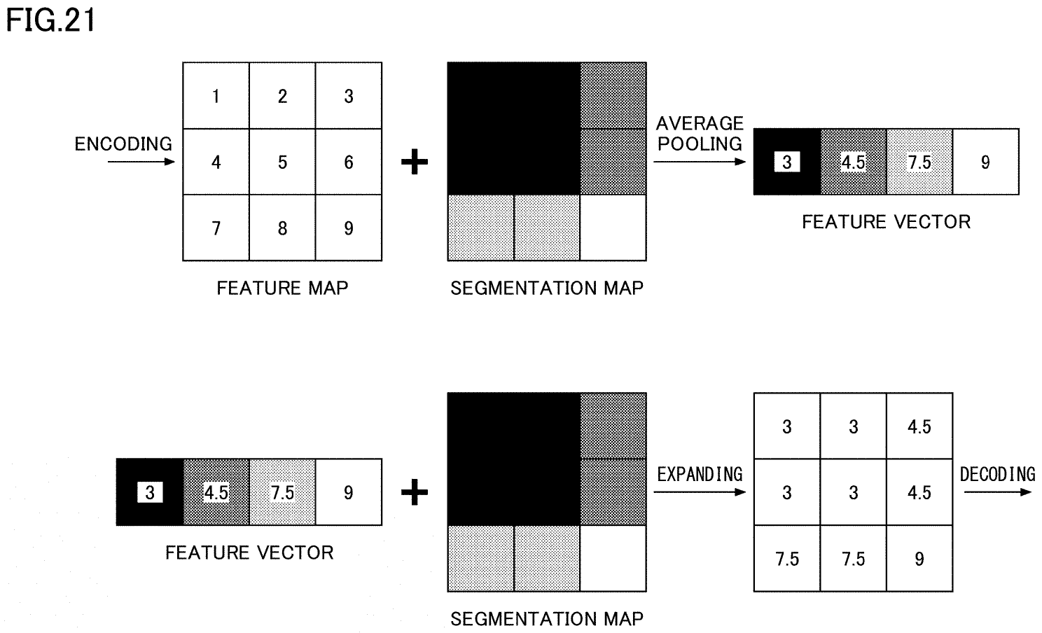

Specifically, the training apparatus 200 inputs an image for training into the encoder 210, acquires a feature map, and acquires an output image from the decoder 230 based on the acquired feature map and the layered segmentation map for training. Specifically, as illustrated in FIG. 21, the training apparatus 200 performs pooling, such as average pooling, with respect to the feature map acquired from the encoder 210 and the layered segmentation map for training to derive a feature vector. The training apparatus 200 expands the derived feature vector by the layered segmentation map, inputs the derived feature map into the decoder 230, and acquires the output image from the decoder 230.

Subsequently, the training apparatus 200 inputs any of a pair of the output image generated from the decoder 230 and the layered segmentation map for training, and a pair of the input image and the layered segmentation map for training into the discriminator 240 and acquires a loss value based on the discrimination result by the discriminator 240. Specifically, if the discriminator 240 correctly discriminates the input pair, the loss value may be set to be zero or the like, and if the discriminator 240 incorrectly discriminates the input pair, the loss value may be set to be a non-zero positive value. Alternatively, the training apparatus 200 may input either the output image generated from the decoder 230 or the input image into the discriminator 240 and acquire the loss value based on the discrimination result by the discriminator 240.

Meanwhile, the training apparatus 200 acquires the loss value representing the difference in the feature from the feature maps of the output image and the input image. The loss value may be set to be small when the difference in the feature is small, while the loss value may be set to be large when the difference in the feature is large.

The training apparatus 200 updates the parameters of the encoder 210, the decoder 230, and the discriminator 240 based on the two acquired loss values. Upon satisfying a predetermined termination condition, such as completion of the above-described process for the entire prepared training data, the training apparatus 200 provides the ultimately acquired encoder 210 and decoder 230 to the data generation apparatus 100 as a trained encoder 110 and decoder 130.

Further, the training apparatus 200 trains the segmentation model 220 by using a pair of the image for training and the layered segmentation map. For example, the layered segmentation map for training may be created by manually segmenting each object included in the image and labeling each segment with the object.

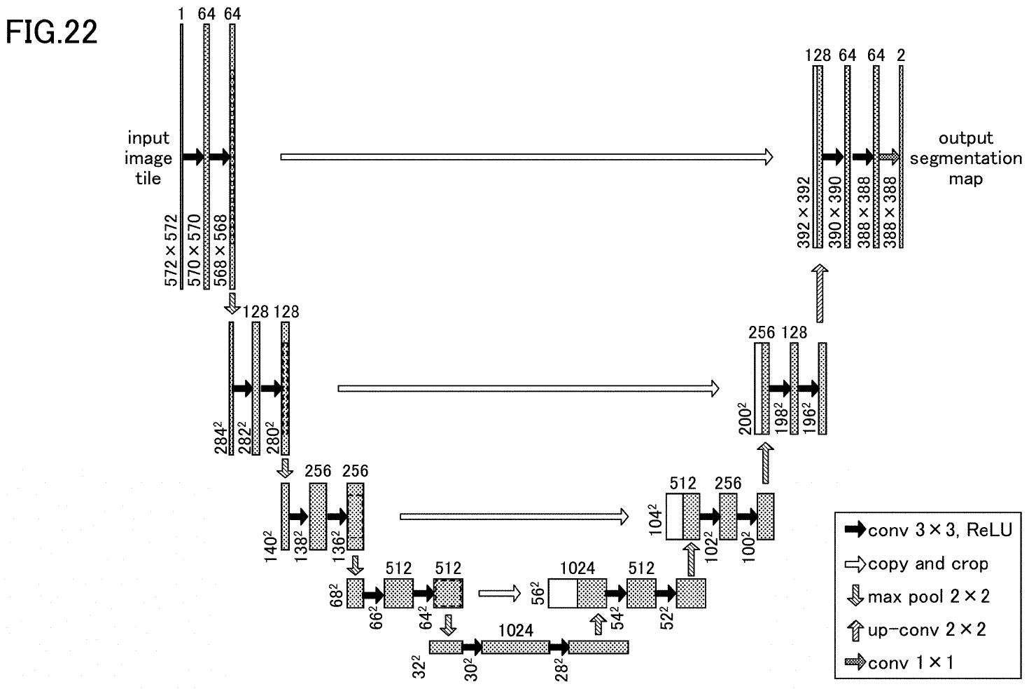

For example, the segmentation model 220 may include a U-Net type neural network architecture as illustrated in FIG. 22. The training apparatus 200 inputs the image for training into the segmentation model 220 to acquire the layered segmentation map. The training apparatus 200 updates the parameters of the segmentation model 220 according to the difference between the layered segmentation map acquired from the segmentation model 220 and the layered segmentation map for training. Upon satisfying a predetermined termination condition, such as completion of the above-described process for the entire prepared training data, the training apparatus 200 provides the ultimately acquired segmentation model 220 as a trained segmentation model 120 to the data generation apparatus 100.

Note that one or more of the encoder 210, the segmentation model 220, and the decoder 230 to be trained may be trained in advance. This case enables to train the encoder 210, the segmentation model 220, and the decoder 230 with less training data.

### Training Process (Model Generation Process)

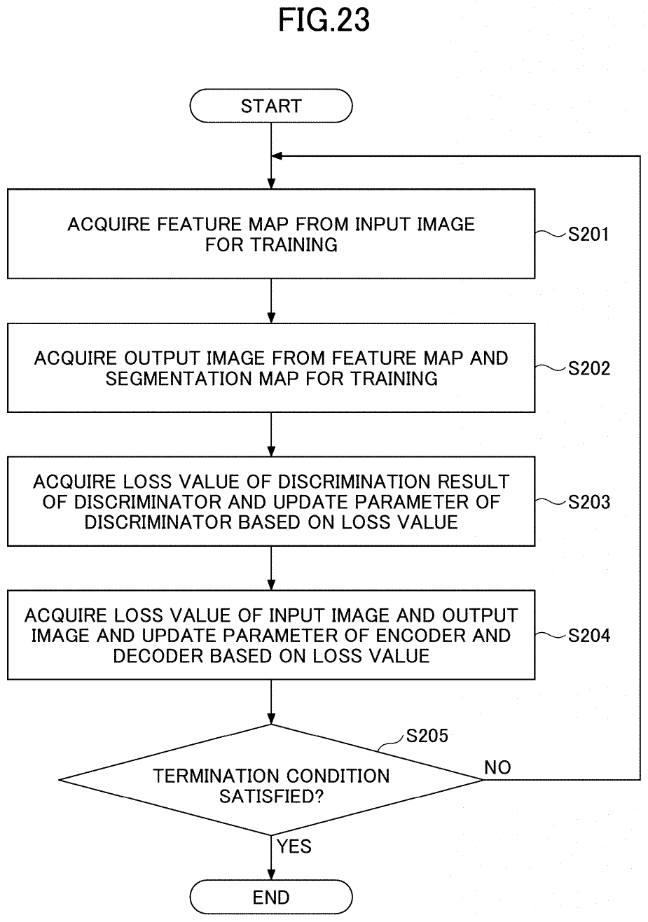

Next, a training process according to an embodiment of the present disclosure will be described with reference to FIG. 23. The training process may be implemented by the training apparatus 200 described above, and may be implemented, for example, by one or more processors or processing circuit of the training apparatus 200 that executes programs or instructions. FIG. 23 is a flowchart illustrating a training process according to an embodiment of the present disclosure.

As illustrated in FIG. 23, in step S201, the training apparatus 200 acquires a feature map from the input image for training. Specifically, the training apparatus 200 inputs the input image for training into the encoder 210 to be trained and acquires the feature map from the encoder 210.

In step S202, the training apparatus 200 acquires the output image from the acquired feature map and the layered segmentation map for training. Specifically, the training apparatus 200 performs a pooling, such as average pooling, with respect to the feature map acquired from the encoder 210 and the layered segmentation map for training to derive a feature vector. Subsequently, the training apparatus 200 expands the derived feature vector by the layered segmentation map for training to derive the feature map. The training apparatus 200 inputs the derived feature map into the decoder 230 to be trained and acquires the output image from the decoder 230.

In step S203, the training apparatus 200 inputs either a pair of the input image and the layered segmentation map for training or a pair of the output image and the layered segmentation map for training into the discriminator 240 to be trained.

Subsequently, the discriminator 240 discriminates whether the input pair is the pair of the input image and the layered segmentation map for training or the pair of the output image and the layered segmentation map for training. The training apparatus 200 determines the loss value of the discriminator 240 according to the correctness of the discrimination result of the discriminator 240 and updates the parameter of the discriminator 240 according to the determined loss value.

In step S204, the training apparatus 200 determines the loss value according to the difference of the feature maps between the input image and the output image and updates the parameters of the encoder 210 and the decoder 230 according to the determined loss value.

In step S205, the training apparatus 200 determines whether the termination condition is satisfied and terminates the training process when the termination condition is satisfied (S205: YES). On the other hand, if the termination condition is not satisfied (S205: NO), the training apparatus 200 performs steps S201 to S205 with respect to the following training data. Here, the termination condition may be steps S201 to S205 having been performed with respect to the entire prepared training data and the like.

### Hardware Configuration

A part or all of each apparatus (the data generation apparatus 100 or the training apparatus 200) according to the above-described embodiments may be partially or entirely configured by hardware or may be configured by information processing of software (i.e., a program) executed by a processor, such as a CPU or a graphics processing unit (GPU). If the device is configured by the information processing of software, the information processing of software may be performed by storing the software that achieves at least a portion of a function of each device according to the present embodiment in a non-transitory storage medium (i.e., a non-transitory computer-readable medium), such as a flexible disk, a compact disc-read only memory (CD-ROM), or a universal serial bus (USB) memory, and causing a computer to read the software. The software may also be downloaded through a communication network. Additionally, the information processing may be performed by the hardware by implementing software in a circuit such as an application specific integrated circuit (ASIC) or a field programmable gate array (FPGA).

The type of the storage medium storing the software is not limited. The storage medium is not limited to a removable storage medium, such as a magnetic disk or an optical disk, but may be a fixed storage medium, such as a hard disk or a memory. The storage medium may be provided inside the computer or outside the computer.

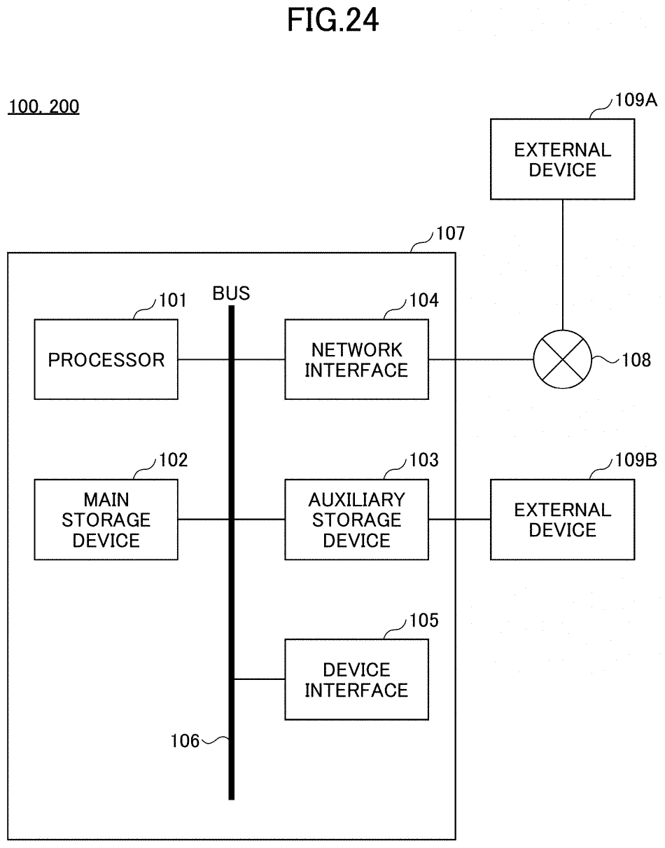

FIG. 24 is a block diagram illustrating an example of a hardware configuration of each apparatus (the data generation apparatus 100 or the training apparatus 200) according to the above-described embodiments. Each apparatus includes, for example, a processor 101, a main storage device (i.e., a main memory) 102, an auxiliary storage device (i.e., an auxiliary memory) 103, a network interface 104, and a device interface 105, which may be implemented as a computer 107 connected through a bus 106.

The computer 107 of FIG. 24 may include one of each component, but may also include multiple units of the same component. Additionally, although a single computer 107 is illustrated in FIG. 24, the software may be installed on multiple computers and each of the multiple computers may perform the same process of the software or a different part of the process of the software. In this case, each of the computers may communicate with one another through the network interface 104 or the like to perform the process in a form of distributed computing. That is, each apparatus (the data generation apparatus 100 or the training apparatus 200) according to the above-described embodiments may be configured as a system that achieves the function by causing one or more computers to execute instructions stored in one or more storage devices. Further, the computer may also be configured as a system in which one or more computers provided on the cloud process information transmitted from a terminal and then transmit a processed result to the terminal.

Various operations of each apparatus (the data generation apparatus 100 or the training apparatus 200) according to the above-described embodiments may be performed in parallel by using one or more processors or using multiple computers through a network. Various operations may be distributed to multiple arithmetic cores in the processor and may be performed in parallel. At least one of a processor or a storage device provided on a cloud that can communicate with the computer 107 through a network may be used to perform some or all of the processes, means, and the like of the present disclosure. As described, each apparatus according to the above-described embodiments may be in a form of parallel computing system including one or more computers.

The processor 101 may be an electronic circuit including a computer controller and a computing device (such as a processing circuit, a CPU, a GPU, an FPGA, or an ASIC). Further, the processor 101 may be a semiconductor device or the like that includes a dedicated processing circuit. The processor 101 is not limited to an electronic circuit using an electronic logic element, but may be implemented by an optical circuit using optical logic elements. Further, the processor 101 may also include a computing function based on quantum computing.

The processor 101 can perform arithmetic processing based on data or software (i.e., a program) input from each device or the like in the internal configuration of the computer 107 and output an arithmetic result or a control signal to each device. The processor 101 may control respective components constituting the computer 107 by executing an operating system (OS) of the computer 107, an application, or the like.

Each apparatus (the data generation apparatus 100 or the training apparatus 200) according to the above-described embodiments may be implemented by one or more processors 101. Here, the processor 101 may refer to one or more electronic circuits disposed on one chip or may refer to one or more electronic circuits disposed on two or more chips or two or more devices. If multiple electronic circuits are used, each electronic circuit may be communicated by wire or wireless.

The main storage device 102 is a storage device that stores instructions and various data executed by the processor 101. The information stored in the main storage device 102 is read by the processor 101. The auxiliary storage device 103 is a storage device other than the main storage device 102. These storage devices indicate any electronic component that can store electronic information and may be semiconductor memories. The semiconductor memory may be either a volatile memory or a non-volatile memory. The storage device for storing various data in each apparatus (the data generation apparatus 100 or the training apparatus 200) according to the above-described embodiments may be implemented by the main storage device 102 or the auxiliary storage device 103, or may be implemented by an internal memory embedded in the processor 101. For example, the storage portion according to the above-described embodiments may be implemented by the main storage device 102 or the auxiliary storage device 103.

To a single storage device (i.e., one memory), multiple processors may be connected (or coupled) or a single processor may be connected. To a single processor, multiple storage devices (i.e., multiple memories) may be connected (or coupled). If each apparatus (the data generation apparatus 100 or the training apparatus 200) according to the above-described embodiments includes at least one storage device (i.e., one memory) and multiple processors connected (or coupled) to the at least one storage device (i.e., one memory), at least one of the multiple processors may be connected to the at least one storage device (i.e., one memory). Further, this configuration may be implemented by storage devices (i.e., memories) and processors included in the plurality of computers. Further, the storage device (i.e., the memory) may be integrated with with the processor (e.g., a cache memory including an L1 cache and an L2 cache).

The network interface 104 is an interface for connecting to the communication network 108 by wireless or wired. As the network interface 104, any suitable interface, such as an interface conforming to existing communication standards, may be used. The network interface 104 may exchange information with an external device 109A connected through the communication network 108. The communication network 108 may be any one of a wide area network (WAN), a local area network (LAN), a personal area network (PAN), or a combination thereof, in which information is exchanged between the computer 107 and the external device 109A. Examples of the WAN include the Internet, examples of the LAN include IEEE 802.11 and Ethernet (registered trademark), and examples of the PAN include Bluetooth (registered trademark) and near field communication (NFC).

The device interface 105 is an interface, such as a USB, that directly connects to the external device 109B.

The external device 109A is a device connected to the computer 107 through a network. The external device 109B is a device connected directly to the computer 107.

The external device 109A or the external device 109B may be, for example, an input device. The input device may be, for example, a camera, a microphone, a motion capture, various sensors, a keyboard, a mouse, or a touch panel or the like, and provides obtained information to the computer 107. The input device may also be a device including an input unit, a memory, and a processor, such as a personal computer, a tablet terminal, or a smartphone.

The external device 109A or the external device 109B may be, for example, an output device. The output device may be, for example, a display device, such as a liquid crystal display (LCD), a cathode-ray tube (CRT), a plasma display panel (PDP), or an organic electro luminescence (EL) panel, or may be a speaker or the like that outputs the voice. The output device may also be a device including an output unit, a memory, and a processor, such as a personal computer, a tablet terminal, or a smartphone.

The external device 109A or the external device 109B may be a storage device (i.e., a memory). For example, the external device 109A may be a storage such as a network storage, and the external device 109B may be a storage such as an HDD.

The external device 109A or the external device 109B may be a device having functions of some of the components of each apparatus (the data generation apparatus 100 or the training apparatus 200) according to the above-described embodiments. That is, the computer 107 may transmit or receive some or all of processed results of the external device 109A or the external device 109B.

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), if the expression such as “data as an input”, “based on data”, “according to data”, or “in accordance with data” (including similar expressions) is used, unless otherwise noted, a case in which various data itself is used as an input and a case in which data obtained by processing various data (e.g., data obtained by adding noise, normalized data, and intermediate representation of various data) is used as an input are included. If it is described that any result can be obtained “based on data”, “according to data”, or “in accordance with data”, a case in which a result is obtained based on only the data is included, and a case in which a result is obtained affected by another data other than the data, factors, conditions, and/or states may be included. If it is described that “data is output”, unless otherwise noted, a case in which various data is used as an output is included, and a case in which data processed in some way (e.g., data obtained by adding noise, normalized data, and intermediate representation of various data) is used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporarily program (i.e., an instruction). If the element A is a dedicated processor or a dedicated arithmetic circuit, a circuit structure of the processor may be implemented so as to actually perform the operation B irrespective of whether the control instruction and the data are actually attached.

In the present specification (including the claims), if a term indicating containing or possessing (e.g., “comprising/including” and “having”) is used, the term is intended as an open-ended term, including an inclusion or possession of an object other than a target object indicated by the object of the term. If the object of the term indicating an inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number is used in another description (i.e., (i.e., an expression using “a” or “an” as an article), it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, states, and/or the like, and that the advantage/result is not necessarily obtained by the configuration. The advantage/result is merely an advantage/result that results from the configuration described in the embodiment when various factors, conditions, states, and/or the like are satisfied, and is not necessarily obtained in the claimed invention that defines the configuration or a similar configuration.

In the present specification (including the claims), if a term such as “maximize” is used, it should be interpreted as appropriate according to a context in which the term is used, including obtaining a global maximum value, obtaining an approximate global maximum value, obtaining a local maximum value, and obtaining an approximate local maximum value. It also includes determining approximate values of these maximum values, stochastically or heuristically. Similarly, if a term such as “minimize” is used, they should be interpreted as appropriate, according to a context in which the term is used, including obtaining a global minimum value, obtaining an approximate global minimum value, obtaining a local minimum value, and obtaining an approximate local minimum value. It also includes determining approximate values of these minimum values, stochastically or heuristically. Similarly, if a term such as “optimize” is used, the term should be interpreted as appropriate, according to a context in which the term is used, including obtaining a global optimum value, obtaining an approximate global optimum value, obtaining a local optimum value, and obtaining an approximate local optimum value. It also includes determining approximate values of these optimum values, stochastically or heuristically.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while another hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data.

Although the embodiments of the present disclosure have been described in detail above, the present disclosure is not limited to the individual embodiments described above. Various additions, modifications, substitutions, partial deletions, and the like may be made without departing from the conceptual idea and spirit of the invention derived from the contents defined in the claims and the equivalents thereof. For example, in all of the embodiments described above, if numerical values or mathematical expressions are used for description, they are presented as an example and are not limited thereto. Additionally, the order of respective operations in the embodiment is presented as an example and is not limited thereto.

What is claimed is:

1. A data generation method comprising:
generating, by at least one processor, an output image by using a first image, a first segmentation map, and a first neural network, the first segmentation map being a layered segmentation map.

2. The data generation method as claimed in claim 1, wherein generating the output image includes:
generating, by the at least one processor, a first feature map by inputting the first image into a second neural network; and
generating, by the at least one processor, the output image by using the first feature map, the first segmentation map, and the first neural network.

3. The data generation method as claimed in claim 2, wherein generating the output image includes:
generating, by the at least one processor, a second feature map based on the first feature map and the first segmentation map; and
generating, by the at least one processor, the output image by inputting the second feature map into the first neural network.

4. The data generation method as claimed in claim 3, wherein generating the output image includes:
generating, by the at least one processor, a feature vector based on the first feature map and a second segmentation map, the second segmentation map being a layered segmentation map; and
generating, by the at least one processor, the second feature map based on the feature vector and the first segmentation map.

5. The data generation method as claimed in claim 1, wherein the first segmentation map is generated from the first image or a second image.

6. The data generation method as claimed in claim 5, further comprising:
generating, by the at least one processor, the first segmentation map by inputting the first image or the second image into a third neural network.

7. The data generation method as claimed in claim 1, wherein the first segmentation map is generated by editing a segmentation map generated from the first image or a second image.

8. The data generation method as claimed in claim 7, further comprising:
generating, by the at least one processor, the first segmentation map based on an editing instruction from a user.

9. The data generation method as claimed in claim 4, wherein the second segmentation map is generated from the first image.

10. The data generation method as claimed in claim 9, further comprising:
generating, by the at least one processor, the second segmentation map by inputting the first image into a third neural network.

11. The data generation method as claimed in claim 1, wherein the first segmentation map includes a plurality of layers, each layer corresponding to any one of eyebrows, a mouth, nose, eyelashes, black eyes, white eyes, clothing, hairs, a face, a skin, and a background.

12. The data generation method as claimed in claim 1, wherein the first segmentation map has a structure in which a plurality of layers are superimposed.

13. The data generation method as claimed in claim 1, wherein the first segmentation map includes a plurality of pixels that are each labeled with two or more labels.

14. The data generation method as claimed in claim 13, wherein the output image reflects an object being in a highest layer of each pixel of the first segmentation map.

15. A data displaying method implemented by at least one processor, the method comprising:
displaying a first segmentation map on a display device;
displaying information on a plurality of layers to be edited on the display device;
obtaining an editing instruction relating to a first layer included in the plurality of layers from a user;
displaying a second segmentation map, generated by editing the first layer of the first segmentation map based on the editing instruction from the user, on the display device; and
displaying an output image, generated based on a first image and the second segmentation map, on the display device.

16. The data displaying method as claimed in claim 15, wherein the first segmentation map is generated from the first image or generated from a second image.

17. The data displaying method as claimed in claim 15, wherein the plurality of layers includes a layer corresponding to any one of eyebrows, a mouth, nose, eyelashes, black eyes, white eyes, clothing, hairs, a face, a skin, and a background.

18. The data displaying method as claimed in claim 15, wherein the first segmentation map includes at least the first layer and a second layer,
wherein displaying the first segmentation map on the display device further includes:
switching, by the at least one processor, between displaying and hiding the second layer based on an instruction from the user.

19. A data generation apparatus comprising:
at least one memory; and
at least one processor configured to:
generate an output image by using a first image, a first segmentation map, and a first neural network, the first segmentation map being a layered segmentation map.

20. The data generation apparatus as claimed in claim 19, wherein the at least one processor is further configured to:
generate a first feature map by inputting the first image into a second neural network; and
generate the output image by using the first feature map, the first segmentation map, and the first neural network.

21. The data generation apparatus as claimed in claim 19, wherein the first segmentation map is generated by editing a segmentation map generated from the first image or a second image.

22. A data display system comprising:
at least one memory; and
at least one processor configured to:
display a first segmentation map on a display device;
display information on a plurality of layers to be edited on the display device;
obtain an editing instruction relating to a first layer included in the plurality of layers from a user;
display a second segmentation map, generated by editing the first layer of the first segmentation map based on the editing instruction from the user, on the display device; and
display an output image, generated based on a first image and the second segmentation map, on the display device.

23. The data display system as claimed in claim 22, wherein the first segmentation map is generated from the first image or generated from a second image.

24. The data display system as claimed in claim 22, wherein the plurality of layers includes a layer corresponding to any one of eyebrows, a mouth, nose, eyelashes, black eyes, white eyes, clothing, hairs, a face, a skin, and a background.

25. The data display system as claimed in claim 22, wherein the first segmentation map includes at least the first layer and a second layer, and
wherein the at least one processor is further configured to switch between displaying and hiding the second layer based on an instruction from the user.
